(19) United States
(12) Patent Application Publication
(10) Pub. No.: US 2011/0048282 A1
(43) Pub. Date: Mar. 3, 2011

(54) HYBRID NANOPARTICLES WITH CONTROLLED MORPHOLOGY AND THEIR USE IN THERMOPLASTIC POLYMER MATRIX NANOCOMPOSITES

(76) Inventors: Raúl QUIJADA ABARCA, Santiago (CL); Edwin Moncada Acevedo, Santiago (CL)

(21) Appl. No.: 12/846,381

(22) Filed: Jul. 29, 2010

Related U.S. Application Data
(60) Provisional application No. 61/229,351, filed on Jul. 29, 2009.

(51) Int. Cl. C09D 1/00

(52) U.S. Cl. 106/287.13

(57) ABSTRACT

Nanoparticles with controlled and highly monodispersed morphology made using a modified Stöber sol-gel process. The hybrid silica nanoparticles with controlled morphology having uniform size, shape or both, and contain an aliphatic amine of 2-20 carbon atom, or an alkoxide compound selected from the group consisting of siliceous alkoxide (R′_{(X)}—Si—(OR″)_{(4-X)}), and/or titanium alkoxide (R′_{(X)}—Ti—(OR″)_{(4-X)}) and/or zirconium alkoxide (R′_{(X)}—Zr—(OR″)_{(4-X)}), wherein R′ group can be equal or different that R″, and the R group in the chemical structure are between 1 to 18 carbon atoms, and mixtures thereof, having from one to four alkoxy groups, or a combination of said aliphatic amine and said alkoxide compound.

### BACKGROUND OF THE INVENTION

Nanotechnology represents an up-to-date, widely developed discipline. One of its application fields comprises preparing materials, commonly named nanocomposites, in which the interaction between the components occurs in nanometric or molecular scale and, hence, different properties in comparison to conventional material. Due to their special properties, the nanocomposites present applications in several technological areas, such as catalysis, electronics, magnetic devices, paints and coatings.

The nanocomposites are hybrid materials in which one of the components is the matrix, where the particles of the second component are dispersed, which is a charge of inorganic nature with nanometric dimensions, named nanoparticles.

Nano-sized materials exist with the nano-size in three dimensions (nano-particles), two dimensions (nano-tubes having a nano sized cross section, but indeterminate length) or one dimension (nano-layers having a nano-sized thickness, but indeterminate area). Nano-sized materials are generally of mineral nature. They can comprise aluminum, oxide, silica, etc.

Sol-gel process, described by Stober et al., (W. Stober, A. Fink, E. Bohn, J. Colloid Interface Science Vol. 26, 62, 1968, the disclosure of which is incorporated by reference in its entirety) allows obtaining silica particles with high surface area and comprises one of the most recurrent and currently used procedures. This sol-gel method allows obtaining materials through the preparation of a sol, the sol gelation and the elimination of the solvent i.e., the formation of nanoparticles with mono-dispersed silica by the hydrolysis and condensation of alkoxides (siliceous alkoxide and/or titanium alkoxide and/or zirconium alkoxide), the most usually siliceous alkoxide used, is the tetra-ethyl orthosilicate (TEOS) in ethanol with ammonia as a catalyst. Since then, many changes have been developed and have introduced new variables to try to have control over the size and morphology of the particles.

A large majority of contributions related to the sol-gel technique to obtain nanosilica show the synthesis of nanosilica from TEOS or its derivative in alcohol and ester in the presence of ammonia, as well as the use of commercial nanosilica modified in its surface by reactions of graft for their implementation, e.g. in the nanocomposite formation (J. Chrusciel and L. Slusarski, Materials Science, Vol. 21, 461, 2003; C. L. Wu et. al., Compos Sci Technol Vol. 62, 1327, 2002, the disclosures of which are incorporated by reference in their entirety).

Similarly, Breck and his colleagues at Mobil Oil Corporation (U.S. Pat. No. 3,130,007, 1964 the disclosure of which is incorporated by reference in its entirety) were the pioneers in the use of structural models for the synthesis of silicates and structurally ordered aluminosilicates, also called mesoporous molecular sieves. These materials were synthesized in basic solution and used long alkyl chain modelers, which were subsequently removed to obtain the mesoporous silica. Many are the models used, in particular, can organic molecules, cationic, anionic, or neutral. Copolymers can also be used to present features of different polarity.

The U.S. patent app. 2006/063876 (2006) to produce nanosilicas films, US 2003/157330 (2003) to obtain high porosity nanosilicas, CN 1752113 (2006) to obtain silica nanoparticles embedded in a matrix of polyolefin catalysts by using TiCl₄ or alkoxy-titanium, which generates nanoparticles, and JP Publ. 2004315300 to obtain silica dispersed with a diameter of greater than 1 nm to less than 10 nm by the addition of siliceous alkoxide to an aqueous solution of alcohol and ammonia through the reaction process of condensation or hydrolysis/dehydration, the disclosures of which are incorporated by reference in their entirety, are some examples that demonstrate the myriad alternatives for these nanoparticles to be obtained. Unfortunately, these techniques have not been proven to be particularly efficient for dispersion of these nanoparticles on the polymeric matrix.

Moncada et. al. (Nanotechnology, Vol. 18, 335606, 2007, the disclosure of which is incorporated by reference in its entirety) has described the collection of lamellar and spherical nanoparticles by a sol-gel process by using a single eight carbon aliphatic amine atoms as morphology modifiers of nanoparticles, used to develop nanocomposites based on a polypropylene matrix, or via masterbatch mixture of nanoparticles with a single commercial compatibilizer—polypropylene grafted with maleic anhydride—and a weight ratio of 1/3 nanoparticle/compatibilizer.

In recent years, the study of controlling the structure of inorganic materials by using organic compounds has been paid much attention, since it is available for obtaining a material having novel configuration or structure. Particularly, the preparation of inorganic ultra-fine particles or porous materials by using surfactants is attracting people's attention in both basic and application field.

The incorporation of inorganic nanometric particles in polymeric matrices lead to an increase in the mechanical strength, hardness and thermal stability of the polymers, as well as improved barrier and flame delay properties, due to the synergy between the different components used. Studies on preparation and characterization of nanocomposites and the interactions and effects that occur at the molecular level have been explored, in an attempt to obtain improved and better oriented materials to the application for which they are intended.

According to the intended application, several types of charges or compounds may be used, which are different from each other, for example, concerning morphological properties, thermal resistance or chemical reactivity. Among the most commonly used charges for polymeric matrix nanocomposites are the clays and silicates the morphology lamellar or laminar, carbonates, sulfates, aluminum-silicates and metallic oxides.

Particles with nanometric dimensions are usually hydrophilic, and, hence, before they are dispersed in the polymeric matrix, which is usually hydrophobic-like, they need to be modified, so as to become compatible with the polymers.

Agents able to chemically modify the structure of inorganic charges and/or of the polymeric matrix are used to increase chemical compatibility between the inorganic charges and the polymeric matrix, providing, hence, better dispersion. Thus, the interaction between the components is improved, both by the previous insertion of a hydrophilic monomer in the polymeric chain, or by organic passivation of inorganic nanoparticles surface. Thereupon, polyolefin modified with polar groups are used as compatibleness agents in olefin polymers compositions containing nanocharges (nanoparticle components). The mixture between the nanocomposite components can be obtained by simple intercalation, which consists of inserting the polymeric chain in empty spaces in the inorganic solid structure. These empty spaces are named interlamellar galleries, and can be enlarged with previous use of specific substances, named expansion or swelling agents.

On the other hand, for the mixture between the nanoparticles and polymeric matrix to occur properly, the exfoliation of particles with lamellar inorganic structure, such as clays, is pursued, which comprises its total or partial delamination, attained by chemical transformation of its structure and mechanical stirring and/or ultrasound application. The purpose of the chemical transformation is to modify the clays polarity, increasing, thus, the interlamellar space, facilitating later exfoliation.

A great number of patents and publications describing the use of intercalated clays upon nanocompo site preparations are found in the state of the technique.

The document WO 2004/041721, the disclosure of which is incorporated by reference in its entirety, describes a process for preparing a nanocomposite based on polyolefin comprising a mixture, in the molten state, of the polyolefin, nanoparticles and a non-ionic tenso active compound. In this process the non-ionic tenso active compound is responsible for the intercalation and exfoliation of the nanoparticles and dispersed in the matrix of the polyolefin forming the nanocomposite.

The exfoliation of inorganic charge particles for nanocomposites preparation, according to U.S. Pat. No. 6,271,298, the disclosure of which is incorporated by reference in its entirety, is facilitated by submitting the clay to a prior surface treatment, with negatively charged organic molecules. Likewise, with the purpose of providing dispersion of natural phyllosilicates or hydrophilic clays in several polymers, a surface treatment is provided in US Patent publ. 2004/0214921, the disclosure of which is incorporated by reference in its entirety. The phyllosilicate/polymer nanocomposites described in that invention are obtained by means of the absorption of a tensoactive polymer in a surface of a natural phyllosilicate or a phyllosilicate with surface modified with an organic tensoactive.

As it has been previously mentioned, in polymeric nanocomposites, as the clay is polar and inorganic, and therefore, incompatible with organic polymer, it is required to increase the clay compatibility and dispersion within the polymeric matrix.

US Patent Publ US 2004/220305, the disclosure of which is incorporated by reference in its entirety, describes a method to produce a concentrated organophilic silicate through the use of an aqueous suspension or a moist cake of filter from an organophilic silicate with a monomer, an oligomer or a polymer, whose objective is to displace the water associated to the organophilic silicate particles. In that method, the monomer, oligomer or polymer physically displaces the water from the clay agglomerates in the suspension or filter cake, reducing the time and amount of energy spent for organophilic silicate particles drying, before additional processing.

### SUMMARY OF THE INVENTION

A main aspect of this invention is to generate nanoparticles with controlled and highly monodispersed morphology implementing a process for modified synthesis of the classic version of the Stöber sol-gel process. Furthermore, the invention produces nanocomposites polyolefin/nanoparticles with enhanced mechanical and thermal barrier properties. Also an aspect of this invention is a simple procedure for the preparation of nanoparticles and nanocomposites polyolefin/nanoparticle in comparison with those described in the state of the art.

The present invention also relates to nanoparticles for use in the food, pharmaceutical, chemical, automotive and materials industries, and includes the process for obtaining such nanoparticles and also the preparation of nanocomposites using this nanoparticles. Those nanoparticles are: i) silica with spherical morphology, and ii) aluminosilicates with laminar morphology. The nanoparticles arc hybrid and its principal characteristic is high purity and controlled morphology, including uniform size and/or shape. In addition the silica nanoparticles are extreme monodispersed. The nanocomposites obtained with these nanoparticles have improved mechanical, thermal and barrier properties, compared with the same nanocomposites that use clays as nanoparticles such us the hybrid montmorrillonite clays type.

The present invention provides a sol-gel process by using an aliphatic amine to prepare nanoparticles of: i) silica hybrid or nanosilica synthetic inorganic-organic having high purity and spherical morphology, and being highly mono-dispersed, and of ii) synthetic hybrid aluminosilicates with laminar morphology and high purity. These nanoparticles of high purity are used in the food, pharmaceutical, automotive, chemical and materials industry. The present invention also provides a production process for making polyolefin hybrid nanocomposites from the nanoparticles to implement in industrial medicine, food, pharmaceutical, automotive, electronics, packaging, textiles, among other.

The nanocomposites can be developed through one of two process: i) mixing the components using a melt extrusion machine, i.e., the polyolefin melt flow index between 0.1 and 40 [g/10 min], the components including nanoparticles according to the present invention, polypropylene grafted with maleic anhydride and/or polypropylene grafted with itaconic acid, both as a compatibilizing agent and an antioxidant; or ii) an in-situ polymerization reaction, where the nanosilica can be added to a polymerization system, and/or a catalytic system can be supported in the nanosilica, and after to make the polymerization reaction. The present invention provides producing nanocomposites of polyolefins and nanoparticles characterized by high transparency, purity and hybrid characteristic in addition to an enhanced mechanical, thermal and barrier behaviour.

The present invention also relates to the preparation of hybrid nanoparticles with a high level of purity which makes them of great interest in the food industry, pharmaceutical industry, chemical industry, automotive industry and materials in general. Hybrid nanoparticles include hybrid nanoparticles of silica that have been prepared by using the modified sol-gel method including the use of aliphatic amines having 5 to 20 carbon atoms at a concentration of about 0.018-0.030 Molar; and/or siliceous alkoxide (R′_{(X)}—Si—(OR″)_{(4-X)}) and/or titanium alkoxide (R′_{(X)}—Ti—(OR″)_{(4-X)}) and/or zirconium alkoxide (R′_{(X)}—Zr—(OR″)_{(4-X)}), wherein R′ group can be equal or different that R″, and the R group in the chemical structure are between 1 to 18 carbon atoms.

Thus it is possible to obtain synthetic, spherical hybrid silica nanoparticles with a high level of dispersion, which do not form agglomerates between these nanoparticles due to the presence of those aliphatic amines in the resultant silica nanoparticles structure, or due to aliphatic groups (R′) in the chemical structure the alkoxide compound

Furthermore the size of these nanoparticles can be controlled according to the concentration level of the aliphatic amine in the range between 10-100 nanometers.

Hybrid nanoparticles include hybrid synthetic and laminar aluminosilicates obtained by the sol-gel process by using aliphatic amines having 5 to 20 carbon atoms in a composition of about 1.8-3.0 Molar.

Furthermore, the present invention provides the use of the spherical, highly monodispersed silica nanoparticles and the lamellar aluminosilicate for the preparation of nanocomposite hybrids of thermoplastic polymer. In the preparation of the nanocomposites where considered in addition of the nanoparticles, any thermoplastic polymer can be used, including a commercial polypropylene homopolymer having a flow rate of 0.1 and 40 [g/10 min] of the Ziegler-Natta and Metallocenic type as polymeric matrices, along with the use of a commercial compatibilizer including polypropylene grafted with maleic anhydride or also the polypropylene grafted with itaconic acid, and an antioxidant.

The sol-gel process allows the obtaining of nanosilica with a high superficial area and covered by silanol groups and hybrid characteristics (more hydrophobic behavior). The hybrid characteristic provides compatibility between the nanoparticles and polymer. On the other hand when the surface does not have hybrid characteristic or presents low hybrid characteristic, the hydrophilic surface represents deficient compatibilization with polymers like thermoplastic polymers, preventing the nanosilica to wet the polymer. On the contrary, the nanosilica particles with hydrophilic surface easily adhere to each other through hydrogen bridges, forming irregular clusters. These nanosilica clusters form a network structure inside the polymer matrix, blocking it and altering the rheology of nanocomposite, and nanocomposite viscosity will grow with increasing levels of nanosilica in the composition. In another aspect, these clusters would decrease the capacity to increase the level of the nanosilica in the nanocomposite together with the deterioration of the mechanical behavior of thermal nanocomposites with agglomerated nanosilicas. In order to decrease the viscosity and thus increase the nanosilica level, the degree of agglomeration of silica nanoparticles is reduced. It is believed that in the polymeric nanocomposites with totally non-agglomerated nanoparticles, its viscosity is constant and therefore its processability is optimal. The mechanical methods of mixing or dispersion possible to apply to nanoparticles, for example, in high speed cutting or grinding methods, are inefficient in breaking agglomerates due to electrostatic forces that hold together the particles, which are larger than the cutting force created by the velocity gradient of grinding or mixing equipment. In this case, the chemical treatment of the surface of the nanoparticle would be an alternative for better compatibility and dispersion of these nanoparticles in the polymer.

An alternative for obtaining nanocomposites based on thermoplastic polymers is the use of clay smectites. In the formation of these nanocomposites, it has been found that the main difficulty is the low interlaminar spacing of this type of clay in the order of 1 nm. This hinders the insertion of the polymer among the laminar structure to generate the states, intercalation and/or exfoliation in the clay. Another important feature is the lack of homogeneity of the clay and the presence of certain ions as impurities, which give color to the nanocomposites, e.g. the iron, or confers toxicity, for example, in the presence of Cd and Cr. That is the reason why techniques are sought for obtaining synthetic or inorganic clays with lamellar structures that would alter the properties of the polymer when dispersed therein, but without adversely affecting the polymer. The method of sol-gel synthesis has become an important tool for obtaining high purity lamellar or spherical structures. The degree of organization of structures and their properties depend on the nature of the components, whether they are organic, inorganic or hybrid systems in order to generate synergistic interactions. In addition, this sol-gel synthesis method allows modifications in the morphology of the particles which can be obtained as plates, spheres, wires, etc. when structure model modifiers are used. For this reason, the sol-gel technique is of great application in nanoscience where it is possible to obtain nanostructures based on cleaner and lighter chemical processes (low pressure and low temperature chemical processes). This way we deliver constant composition, high purity, nontoxic products, that thus can be used, for example in the food and pharmaceutical industry.

### DESCRIPTION OF THE DRAWINGS

FIG. 1 shows TEM images of the NPSE nanoparticles of Example 1; in 1(a), a reference bar of the size of: 200 nanometers; in 1(b), a reference bar of the size of: 50 nanometers.

FIG. 2 shows a Fourier Transform Infrared Spectroscopy (FTIR) spectrum of the NPSE nanoparticles of Example 1: infrared radiation transmittance of the nanoparticles, in %, matching the Y axis, moreover the wavelength values, in cm⁻¹, in the X axis.

FIG. 3 shows an X-Ray diffraction spectra (XRD): relative intensity in relative units of X-rays diffracted by the NPSL particles of Example 1, corresponding to the Y axis, moreover the values of angle two theta (2 θ) in units of degrees, in the X axis.

FIG. 4 shows a Fourier Transform Infrared Spectroscopy (FTIR) spectrum of the NPSL nanoparticles of Example 2: infrared radiation transmittance of the nanoparticles, in %, matching the Y axis, moreover the wavelength values, in cm⁻¹, in the X axis.

FIG. 5 shows TEM images of the NPS nanoparticles of Example 3: in 5a), a reference bar of the size of: 200 nanometers; in 5(b), a reference bar of the size of: 50 nanometers.

FIG. 6 shows a Fourier Transform Infrared Spectroscopy (FTIR) spectrum of the NPS nanoparticles of Example 3): infrared radiation transmittance of the nanoparticles, in %, matching the Y axis, moreover the wavelength values, in cm⁻¹, in the X axis.

FIG. 7 shows a diagram of the Cell Permeability.

### DETAILED DESCRIPTION OF THE INVENTION

A main aspect of this invention is to generate hybrid and non-hybrid silica nanoparticles of synthetic origin, with a high degree of purity, which are free of toxic compounds to human health, such as cadmium, chromium, etc., and have spherical mono-dispersed morphology, as well as nanoparticles of aluminosilicate and lamellar morphology by applying a modified procedure for the synthesis of the classic version of the sol-gel process. These nanoparticles have a high degree of purity have application in the food, pharmaceutical, chemical, automotive industry and materials in general.

Furthermore the invention provides a procedure for obtaining nanocomposites based in polyolefin and nanoparticles developed in the present invention. These nanocomposites possess improved mechanical and thermal properties for use in the medical, food, pharmaceutical, automotive, electronics, packaging and textile industry, among others. These nanocomposites it is possible to obtain through extrusion process or in-situ polymerization.

Specifically the invention provides a method for making silica and aluminosilicate nanoparticles with controlled morphology having uniform size or uniform shape, or both, by applying a modified version of the classic method of sol-gel described by Stöber. That is, instead of performing the sol-gel process with tetra ethyl orthosilicate (TEOS) and adding a solution of ethanol/ammonium hydroxide, TEOS is hydrolyzed previously in part in an azeotropic solution of ethanol/water (4.4% wt. water) to form siloxane oligomers. Subsequently, an amine is added to obtain aliphatic hybrid nanoparticles (inorganic-organic particles) and thus control their size and state of aggregation of nanoparticles. The nanometric size of particles of silica can be controlled according to the level of concentration of the aliphatic amine, i.e., a lower concentration of the aliphatic amine as greater is the size of the silica nanoparticles.

This invention also provides the elaboration of the lamellar and spherical nanoparticles using inorganic compounds such us siliceous alkoxide (R′_{(X)}—Si—(OR″)_{(4-X)}) and/or titanium alkoxide (R′_{(X)}—Ti—(OR″)_{(4-X)}) and/or zirconium alkoxide (R′_{(X)}—Zr—(OR″)_{(4-X)}), wherein R′ group can be equal or different that R″, and the R group in the chemical structure are between 1 to 18 carbon atoms.

The nanoparticles from this invention could be obtained by either one of the two methods, that is, using:

a) TEOS and aliphatic amine, or

b) Siliceous alkoxide (R′_{(X)}—Si—(OR″)_{(4-X)}) and/or titanium alkoxide (R′_{(X)}—Ti—(OR″)_{(4-X)}) and/or zirconium alkoxide (R′_{(X)}—Zr—(OR″)_{(4-X)}), wherein R′ group can be equal or different that R″, and the R group in the chemical structure are between 1 to 18 carbon atoms.

For purposes of this invention there is a full description for nanoparticles through the above mentioned method (a), but is not excluded from the present invention the nanoparticles production method (b), because the hybrid characteristic and morphology and purity are similar.

This invention involves, in a first aspect, the hybrid silica nanoparticles development and particularly monodispersed spherical made by sol-gel process by using a dilute solution of aliphatic amine (0.018-0.020 Molar) and its application in the preparation of nanocomposites based on polyolefins. Furthermore, the invention also includes the sol-gel process that uses a concentrated solution of aliphatic amine (1.8-2.0 Molar) to develop hybrid laminar aluminosilicate nanoparticles (NPSL).

In the same way and by a sol-gel process similar but without the aliphatic amines, non hybrid silica nanoparticles (NPS), which are spherical or fiber agglomeration morphology (fibrillar), were obtained. Furthermore, by using nanoparticles (NPS) or (NPSL), the present invention also describes the procedure for preparing the hybrid nanocomposites based on polyolefins.

Additionally, this invention includes the development of nanocomposites of the smectite-type clays, as a source of nanoparticles, as a way to establish a comparison of mechanical and thermal properties of the hybrid nanocomposites of the present invention.

The preparation of nanocomposites of this invention is performed by prior obtaining the so-called “masterbatch”, i.e. a mixture of nanoparticles and a compatibilizer component in a composition comprising a ratio at between 1/1-1/5 by weight of nanoparticle/compatibilizer. The compatibilizer used in this invention is polyolefin grafted with either maleic anhydride (PP-g-AM) or itaconic acid (PP-g-IA). Finally the manufacturing process consists of a molten mix of a given quantity of the masterbatch, the polyolefin and an antioxidant by using a non-continuous, or batch, mixer.

Thus the present invention comprises:

I. A sol-gel process using an aliphatic amine to make:
a) spherical and mono-dispersed hybrid silica nanoparticles (NPSE), and
b) hybrid laminar aluminosilicate nanoparticles (NPSL);

II. a sol-gel process in the absence of aliphatic amine to make:
a) spherical hybrid silica nanoparticles with fibrillar agglomeration (NPS); and

III. A nanocomposite preparation process through the mixing of liquified i) polyolefins, ii) compatibilizer, iii) antioxidant, and iv) nanoparticles selected from the group consisting of:
a) spherical and mono-dispersed hybrid silica nanoparticels (NPSE),
b) spherical non-hybrid silica nanoparticles, and with fibrillar agglomeration (NPS),
c) laminar hybrid aluminosilicate nanoparticles (NPSL), and
d) smectic-type clay nanoparticles.

Procedure 1

Processes for the elaboration of hybrid, mono-dispersed and spherical nanoparticles (NPSE), comprising the following steps:
a) Obtaining a suspension A by dissolving TEOS in an organic solvent, including methanol, ethanol, and propanol, at room temperature and under inert gas, including nitrogen gas;
b) Obtaining a B suspension dispersing an aliphatic amine with 10 to 20 carbon atoms, including octadecyl amine (ODA), in an azeotropic mixture of ethanol-water (4.4% by weight H₂O) to produce a composition of aliphatic amine between 0.018-0.030 and subsequent addition of ammonium hydroxide (NH₄OH) by agitation for 20 to 40 minutes, at a temperature between 40° C. and 60° C.;
c) Adding suspension A into suspension B, and then mixing by stirring for 15 to 20 hours, at a temperature between 40° C. and 60° C.

Following step c), a suspension of silica nanoparticles is obtained. The presence of amino groups and silanoles in the surface in these nanoparticles is demonstrated by Fourier Analysis Infrared Spectroscopy (FTIR). The spherical and highly monodispersed morphology of a size from 20 to 30 nm are detected by Analysis of Spectroscopy Electronic Transmission (TEM).

Procedure 2

Process for obtaining lamellar aluminosilicate hybrid nanoparticles (NPSL), comprising the following steps:
a) Obtaining an A suspension by dissolving TEOS in an organic solvent, including methanol, ethanol, and propanol, at room temperature and under an inert atmosphere, for example, nitrogen;
b) Obtaining a B suspension dispersing an aliphatic amine containing 10-20 carbon atoms, such as ODA, at a 1.8-3.0 Molar concentration, in a mixture of ethanol:water 100:80 v/v, at a room temperature of 40-60° C., and adding sodium nitrate (NaNO₃) and aluminum nitrate nona-hydrated (Al₂(NO₃)₃.9H₂O) (ratio p/p Al/TEOS between 1/20 and 1/25) and stirring for 20-40 min at 40 and 60° C.

c) Adding the A suspension in the B suspension, and subsequently mixing by stirring for 25-30 hours at 40° C. and 60° C., to produce an emulsion of silica nanoparticles.

d) Washing and filtering the resulting suspension of step c) with 2.0 liters of an ethanol/water mixture (100:80) at 45-50° C.

e) Drying the resulting filtered powder at a temperature between 60 and 70° C. for 20-24 hours.

Following step e) an emulsion or suspension of aluminosilicate nanoparticles is obtained, characterized by analysis of FTIR, DRX and TEM to determine its composition and laminar morphology.

Procedure 3

Process for obtaining non hybrid, spherical and with fibrillar agglomerations silica nanoparticles (NPS).

The process comprises the following stages:
a) Obtaining a suspension A by dissolving TEOS in an organic solvent such as methanol, ethanol, propanol, among others, at room temperature and inert gas such as nitrogen;
b) Adding to the suspension A to a solution of ammonium hydroxide 25% by weight to obtain a pH between 9-12, by stirring;
c) Stirring for a period of 15 to 20 hours at room temperature, thus obtaining a suspension of silica nanoparticles.

In stage c) a suspension of silica nanoparticles is obtained, characterized by analysis of FTIR, DRX and TEM to demonstrate the presence of silanoles groups on the surface and the fibrillar morphology of these nanoparticles.

Procedure 4

The procedure to obtain nanocomposites based on polyolefins and nanoparticles NPSE or NPS.

The process comprises the following stages:
a) Obtaining nanoparticles NPSE or NPS by the process described in procedure 1 and 2 respectively.
b) Preparation of the masterbatch comprising: mixing into molten in a non continuous mixer at 180-185° C. y 100-110 rpm, of the compatibilizing PP-g-AM, antioxidant as 2,6-di-tert-butyl-p-hydroxy toluene (BTH) and the addition of the suspension of nanoparticles NPSE or NPS. After the addition of nanoparticle suspension mixing is maintained for 10-15 minutes in a flow of inert gas, such as nitrogen, at 180-185° C. and 100-110 rpm. The result thus obtained masterbatch with a ratio of nanoparticles NPSE or NPS/compatibilizer in the range of 1/1-1/5.

c) Obtention of the nanocomposite comprising a mixture of: i) masterbatch, ii) commercial polypropylene, iii) BHT as antioxidant. This mixture is carried out in a Brabender non continuous mixer at 190-195° C. and 100-110 rpm for 10 minutes in a flow of inert gas, such as nitrogen, which objective is to move the oxidizing environment of the air into the chamber and prevent the degradation of polypropylene. The nanocomposite prepared in this manner contains 1.0%-5.0% by weight of nanoparticles NPS or NPSL in the polymer matrix.

Procedure 5

Process for obtaining the nanocomposites based on polyolefins and nanoparticles NPSL.

This process is similar to the one described in the procedure 4. In this case only the mixture is modified by the addition of nanoparticles NPSL in replacement of the nanoparticles suspension NPSE or NPS. The ratio by weight of NPSL/compatibilizer of the mixture comprises between 1/1-1/5.

Procedure 6

Process to obtain nanocomposites based on polyolefins and clay nanoparticles of the smectic type.

The process is similar to the process described on the procedure 4 to obtain nanocomposites based on polyolefins and nanoparticles NPSE or NPS. In this case only stage b) is modified corresponding to the preparation of the masterbatch. This masterbatch is obtained from the addition of the clay nanoparticles of the smectic type in replacement of the suspension of nanoparticles NPS or NPSE. Thus the masterbatch obtained will have the ratio by weight of clay nanoparticles/compatibilizers equivalent to the range 1/1-1/5.

### EXAMPLES

The examples include the methodology described in the sol-gel process consisting in the hydrolysis and condensation of tetra-ethyl orthosilicate (TEOS) in ethanol with ammonia as a catalyst and by using an aliphatic amine to prepare:

Spherical, hybrid, monodispersed silica nanoparticles (NPSE), and

hybrid lamellar aluminosilicate nanoparticles (NPSL)

Together, the sol-gel process similar but without the aliphatic amine to prepare:

non hybrid silica nanoparticles (NPS), spherical and with fibrillar agglomeration

Additionally, this invention considers the methodologies of addition of the nanoparticles NPSE, or NPSL, or NPS to the molten mixture of polyolefins, compatibilizer (polypropylene grafted with maleic anhydride and/or polypropylene grafted with itaconic acid), and antioxidant to prepare:

Nanocomposites based on nanoparticles NPSE or NPSL o NPS, and

Nanocomposites based on clay nanoparticles of the smectic type

### Example 1

### The Methodology for the Preparation of Spherical, Hybrid, Monodispersed Nanoparticles (NPSE)

Two solutions are prepared as follows:

Solution 1: Mixing of 54 millimeters of distilled water, 2.2 millimeters of an ammonium hydroxide (NH₄OH) solution 25% by weight, 23.5 millimeters of ethanol (C2H5OH) and 0.342 grams of octadecyl amine (ODA).

Solution 2: In a preconditioned vessel with inert atmosphere, e.g., nitrogen, 55 millimeters of a TEOS solution was added and 23 millimeters of distilled ethanol (technical grade), and stirred during 10-15 minutes.

Subsequently the solution 1 is added to the solution 2 and is left reacting during 15-20 hours. The obtained suspension containing the nanoparticles NPSE is stored for subsequent use for the formation of nanocomposites based in polyolefin.

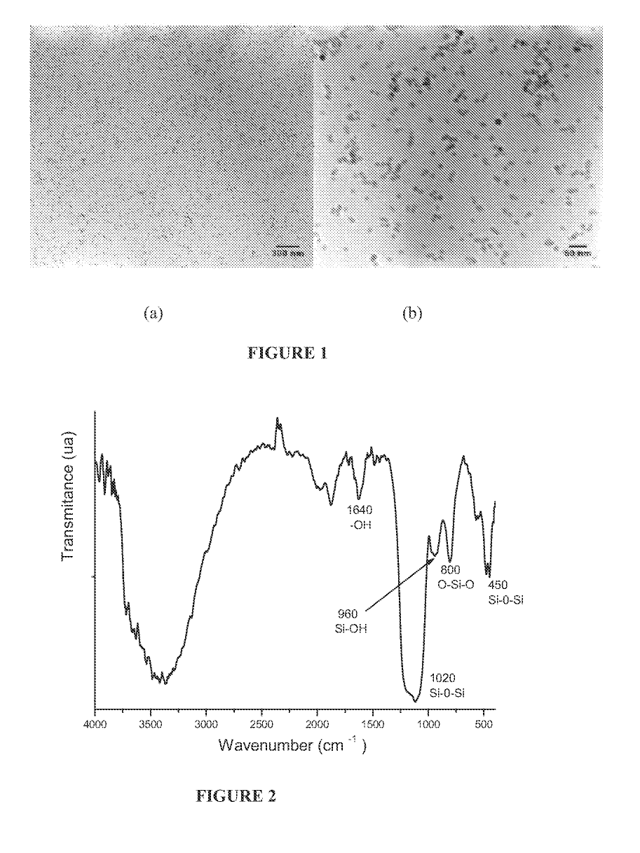

The characterization of the obtained nanoparticles NPSE is made by the transmission electron microscopy (TEM) (FIG. 1) and Fourier Transform Infrared Spectroscopy (FTIR) (FIG. 2).

The TEM image of silica nanoparticles NPSE is shown in FIG. 1 representing their size and degree of dispersion. The FTIR spectrum (FIG. 2) of these hybrid spherical nanoparticles NPSE show the characteristic bands of silica at 450 cm⁻¹ and 1020 cm⁻¹ at 800 cm⁻¹ (bending vibration of O—Si—O) and a 960 cm⁻¹, but a characteristic hand of the ODA at 2918 cm⁻¹, which corresponds to the vibration of the group CH₂ of the amine. The intensity of this band is very weak due to the low concentration of amine used in the process already described and that there is no other bands corresponding to the nitrogen in amine group.

### Example 2

### Methodology for Preparing Hybrid Lamellar Aluminosilicate Nanoparticles NPSL

Two solutions are prepared as follows:

Solution 1: Dissolving 19.55 grams of octadecyl amine (ODA) are dissolved in a mixture of ethanol:water=100:80 v/v at 50° C., subsequently 0.255 g of sodium nitrate (NaNO₃) and 1.12 g of aluminum nitrate nona-hydrated (Al₂(NO₃)₃.9H₂O) under inert gas such as nitrogen are added.

Solution 2: In a preconditioned vessel with inert atmosphere, such as nitrogen, 3.8 millimeters of a TEOS solution was added to 50 millimeters of ethanol at room temperature.

A solution 1 is added slowly to the solution 2 and allowed to react at 50° C. during 25-30 hours. The resulting suspension is washed and filtered with 2.0 liters of a mixture of ethanol:water=100:80 v/v, at a temperature of 45-50° C. and finally is dried during 20 to 24 hours at a temperature of 60-70° C.

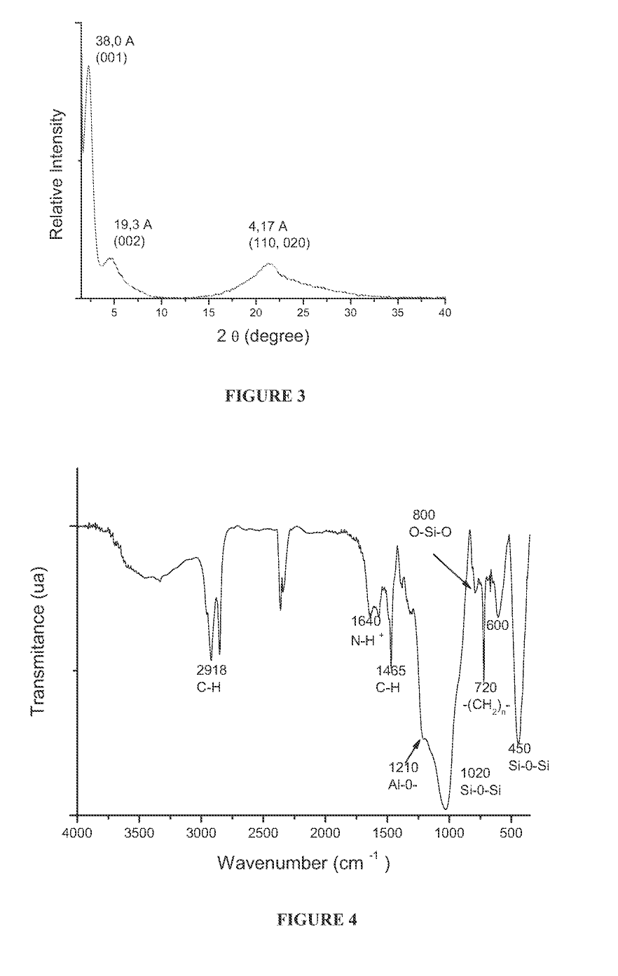

The resulting powder of NPSL nanoparticles obtained is characterized by testing of X-ray diffraction of powder (WAXS) where the plane signals 001 and 002 (FIG. 3) are observed in relation to the 2 theta angles (2θ) 2θ=2.32, equivalent to a distance plane of 001 d1, d1=3.80 nm, and 2θ=4.56, equivalent to a distance plane of 002 d2, d2=1.91 nm, respectively. The distance of the first lens plane (001) is twice the distance of the second lens plane (002), which corresponds to a typical lamellar morphology. The observed signal 2θ=21.26 (d=0.417 nanometers) corresponds to the planes 110 and 020 of the structure of the aluminosilicate. From the above, one can conclude that the silica nanoparticles NPSL obtained have lamellar structures.

On the other hand, in the lamellar hybrid nanoparticles NPSL FT-IR spectrum obtained (FIG. 4) shows the characteristic bands of the link Si—O—Si at 1020 cm⁻¹ and 450 cm⁻¹. In these nanoparticles NPSL characteristic bands of the amine ODA can be found, due to the fact that in the aforementioned process was used in a high concentration (1.8-2.0 Molar). Thus, the absorption bands of 1640 cm⁻¹ and 1570 cm⁻¹ correspond to the protonated primary amine (N—H+) due to its ionic link with the silicate layer. The absorption of the primary C—H groups of ODA is observed at 2918 cm⁻¹ and at 1465 cm⁻¹, as well as by the vibrations from more than four carbon atoms ((—CH₂)n-) at 720 cm⁻¹.

### Example 3

### Methodology for Obtaining the Non-Hybrid Silica Nanoparticles, Spherical and with Fibrillar Agglomeration

The same procedure already described in example 1 applies to the preparation of NPS nanoparticles. In this case only the preparation of solution 1 is modified, as already described on example 1, because the amine with 5-20 carbon atoms, such as ODA, are not added.

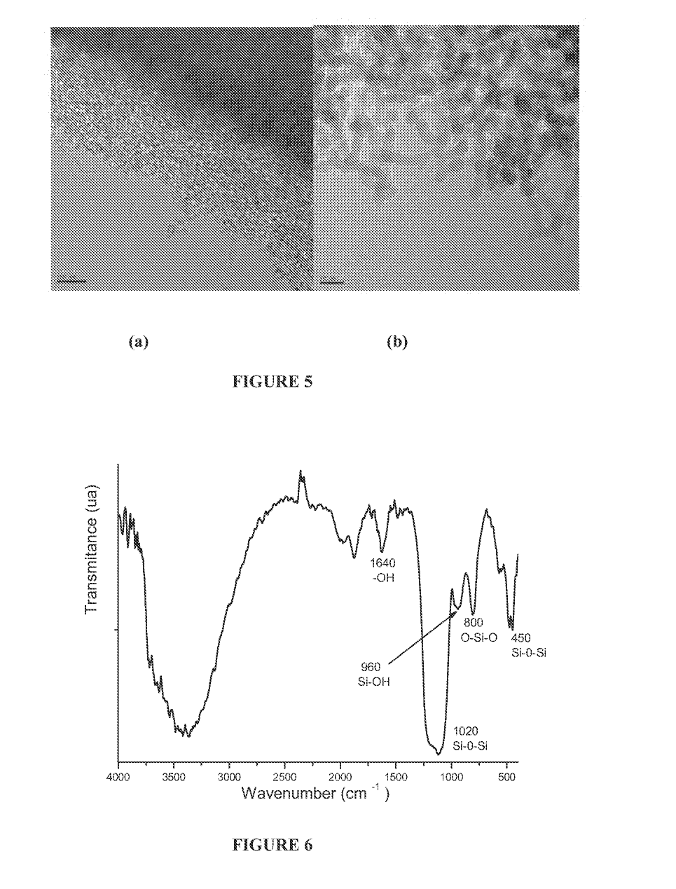

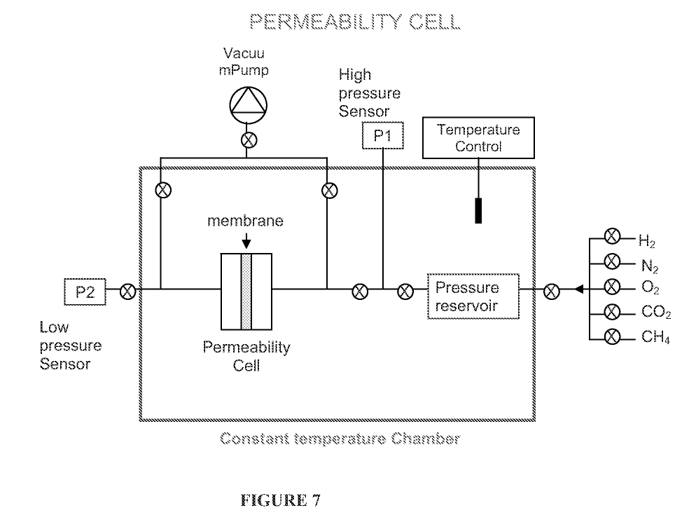

This produces a suspension of silica nanoparticles non-hybrid and agglomerate NPS, due to the lack of the organic component ODA in the surface of the nanoparticles as seen in the TEM images of FIG. 5. Also in the FTIR spectrum of nanoparticles NPS (FIG. 6) shows the absorption bands at 450 cm⁻¹ and 1020 cm⁻¹ corresponding to the tension and bending vibrations of Si—O—Si; at 800 cm⁻¹ appear the bending vibrations of O—Si—O and at 960 cm⁻¹, the symmetrical vibration of silanol group (Si—OH); as well as a wide band corresponding to OH groups of water between 3000 cm⁻¹ and 3700 cm⁻¹, as well as 1640 cm⁻¹. On the other hand, the absence of absorption bands corresponding to the amino groups of the ODA is confirmed.

### Example 4

### Methodology for Preparing Nanocomposites Based on Polyolefins and Nanoparticles NPSE or NPS

The nanocomposite of polyolefin and nanoparticles of this invention, and which is described below, is made of the following materials: i) polyolefin; ii) nanoparticles NPSE or NPS, iii) compatibilizer as a PP-g-AM, and iv) antioxidant.

(i) The commercial polyolefins used were polypropylene (PP) Ziegler-Natta homopolymers of Petroquim S.A. with melt flow index (MFI) of 3 and 26 (ZN340 and ZN150) and PP metallocene homopolymers (MET) synthesized (MET340 and MET190) whose properties are listed in Table 1.

(ii) Nanoparticles: NPSE obtained according to Example 1 and NPS according to Example 3.

(iii) Compatibilizer: PP-g-AM with 0.6 wt % maleic anhydride grafted in polypropylene of Aldrich S.A.

(iv) Antioxidant: 2,6-di-tert-butyl-p-hydroxy toluene (BTH) from the Company Petroquim S.A.

This example describes the steps to obtain a polypropylene nanocomposite with 1% by weight of nanoparticles by using a masterbatch of nanoparticles and commercial compatibilizer (PP-g-AM), for a total mass of 35 grams, equivalent to the capacity of the Brabender non continuous mixer used, which comprises:
a) Obtaining nanoparticles NPSE by the method described in Example 1
b) Preparing the masterbatch comprising: mixing 27.7 grams of compatibilizing PP-g-AM, 0.03 grams of the antioxidant BHT in Brabender non continuous mixer at 180-185° C. and 100-110 rpm. Additionally, add dropwise, 28.2 ml of the suspension of nanoparticles NPSE (Example 1). After completing the addition of this suspension, the mixing is maintained during 10 min in a stream of inert gas, e.g., nitrogen, at 180-185° C. and 100-110 rpm. The masterbatch obtained has a ratio of nanoparticles NPSE/compatibilizer equal to 1/3.
c) Obtention the nanocomposite which comprising a mixture of: i) 1.48 grams of masterbatch ii) 35.5 grams of commercial polypropylene ZN340, iii) 0.02 grams of BHT as an antioxidant. This mixture is carried out in Brabender non continuous mixer at 190-195° C. and 100-110 rpm for 10 min under a stream of inert gas such as nitrogen, which is to move the oxidizing environment of air into the chamber and prevent the degradation of polypropylene. The nanocomposite prepared in this manner contains 1.0% by weight of nanoparticles NPSE in the polymeric matrix.

The same procedure described in this Example 4 is valid for nanocomposites by using nanoparticles NPS prepared according to the methodology described in Example 3. In this case, in part b) of this methodology, the masterbatch is obtained by adding, dropwise, 28.2 ml of the suspension of nanoparticles NPS to the mixture of 27.7 grams of compatibilizing PP-g-AM, and 0.03 grams of antioxidant BHT in Brabender non continuous mixer at 180-185° C. and 100-110 rpm. After completing the addition of this suspension, the mixing is maintained during 10 min in a stream of inert gas, e.g., nitrogen, at 180-185° C. and 100-110 rpm.

TABLE 1
Molecular weight, mechanical and thermal properties of the commercial
Ziegler-Natta (ZN) polypropylene (PP) homopolymers and
synthesized metallocene (ME) used in example 4

| PP | MIF | M̅w̅ (Kg/mol) | Pd ( M̅w̅/ M̅n̅) | E (MPa) | σ_{y} (MPa) | ε (%) | T₅₀ (° C.) |
|---|---|---|---|---|---|---|---|
| ZN 340 | 3 | 340 | 3.9 | 1090 ± 30 | 30 ± 1 | 250 | 319 ± 1 |
| ZN 150 | 26 | 150 | 4.4 | 1092 ± 45 | 32 ± 2 | 20 | 319 ± 1 |
| Met 340 | — | 315 | 1.8 | 1116 ± 32 | 30 ± 1 | 375 | 319 ± 1 |
| Met 190 | — | 190 | 1.8 | 1102 ± 42 | 30 ± 2 | 100 | 319 ± 1 |

MIF = melt flow index (grams of polymer/10 min), 2.16 Kg, 230° C.
E = Tensile Modulus MPa),
σ_{y} = Elastic Limit (MPa),
ε = Deformation at break (%),
T₅₀ = Thermal Stability (° C.).

### Example 5

### Methodology for Obtaining Nanocomposites Based on Polyolefins and Nanoparticles Npls

This procedure is similar to the procedure already described in Example 4. In this case, only the mixture is modified by the addition of nanoparticles NPLS as replacement of the suspension of the nanoparticles NPSE or NPS. The ratio in weight of nanoparticles NPLS/compatibilizer of this mixture is 1/3.

### Example 6

### Methodology for Obtaining Nanocomposites Based on Polyolefins and Clay Nanoparticles Of the Smectic Type

This procedure is similar to the procedure already described in example 4 for obtaining nanocomposites based on polyolefins and nanocomposites NPSE or NPS. In this case, only stage b) is modified corresponding to the preparation of the masterbatch. This masterbatch is obtained by the addition of clay nanoparticles of the smectic type in replacement of the suspension of the nanoparticles NPSE or NPS. Thus the obtained masterbatch will have the weight ratio of clay nanoparticles/compatibilizer equivalent to 1/3.

This procedure is valid to obtain the nanocomposites based on different melt flow indexes polyolefins as summarized in Table 1 and for each one of the smectic type clays as summarized in Table 2.

TABLE 2
Characteristics of the smectic type clays

| Standard | Montmorillonite | Natural Hectorite | Synthetic Hectorite |
|---|---|---|---|
| Code | Mo | Hn | Hs |
| CEC | 83 | 100 | 95 |
| (meq/100 g) | | | |
| SL (nm) | 500 × 1 | 400 × 1 | 50-100 × 1 |
| D₀₀₁ (A) | 12.1 | 11.3 | 14.2 |
| SiO₂ (%) | 54.4 | 51.0 | 51.4 |
| Al₂O₃ (%) | 18.2 | 1.7 | <0.2 |
| Na₂O (%) | 3.5 | 2.9 | 5.2 |
| Li₂O (%) | <0.1 | 0.9 | 0.6 |
| Fe₂O₃ (%) | 3.5 | 0.6 | <0.1 |
| MgO (%) | 2.0 | 21.3 | 23.9 |
| CaO (%) | 0.6 | 1.8 | <0.1 |
| K₂O (%) | 0.2 | 0.4 | <0.01 |
| Empirical | M_{0.62}(Al_{1.58},Mg_{0.22})Si₄O₁₀(OH)₂•nH₂O | M_{0.78}(Al_{0.16}Mg_{2.49},Li_{0.28})Si₄O₁₀(OH)₂•nH₂O | M_{0.79}(Mg_{2.77},Li_{0.19})Si₄O₁₀(OH)₂•nH₂O |
| formula | | | |

CEC: Cationic interchange capacity (meq/100 gr)
SL: Lamellar Size (nanometers)

Mechanical and Thermal Properties of the Nanocomposites Obtained in this Invention

The tests carried out to verify the mechanical, thermal and the X-ray diffraction analysis (DRX) of the nanocomposites obtained according to examples 4, 5 and 6, based on propylene polymers of different melt flow indexes and type of polypropylene (Ziegler Natta or Metallocenic) and silica nanoparticles or aluminum silicate (NPSE, NPS or NPSL) or clays of the smectic type together with PP-g-AM as compatibilizers and antioxidants were:
The tensile mechanical tests according to ASTM D 638, to determine the tensile modulus (E) in Mega-Pascal (MPa), tensile strength (σ_{y}) in (MPa) and % of deformation at break (ε).
The thermal tests by thermal gravimetric analysis that allows obtaining the thermal decomposition temperature evaluated as the temperature corresponding to a 50% of decomposition, codified as “T₅₀”.
Tests of X-ray diffraction to verify qualitatively the state of exfoliation or of intercalation of materials where clays or lamellar nanoparticles (NPSL) were used. In the case of materials with spherical nanoparticles (NPSE or NPS) the characterization is not relevant for this technique.

The results of the thermal tests summarized in Table 3 for the nanocomposites obtained according to Examples 4, 5 and 6 of this invention allows to determine they are characterized as follows:
An increased thermal stability (T₅₀) of the order of 25 to 35° C. in relation to the polyolefin alone,
An increased thermal stability (T₅₀) of the nanocomposites in relation to the polyolefin alone independent of the melt flow indexes of the polyolefins used in the preparation, and
The highest thermal stability (T₅₀) of the nanocomposites in relation to the polyolefin alone is not influenced by the process of obtaining the polyolefin, i.e. if the polymerization process uses a Ziegler-Natta type catalyst or Metallocene in obtaining the polyolefin.

TABLE 3
Thermal stability (T₅₀ ° C.) of the nanocomposites obtained
using 1% of nanoparticles NPSE, NPS or NPSL obtained by
the modified sol-gel method of this invention, 3% p/p de PP-g-
AM compabitilizer and different polypropylenes (PP)

| PP | NPS | NPSE | NPSL |
|---|---|---|---|
| ZN340 | 344 | 349 | 351 |
| ZN150 | 351 | 349 | 350 |
| Met 340 | 351 | 350 | 350 |

T₅₀ Polypropylene = 319° C.

The mechanical properties of the nanocomposites based on polyolefins and PP-g-AM (Table 4) as compatibilizing agent, prepared in this invention (Examples 4, 5 and 6) with nanoparticles NPSE or NPSL or NPS are characterized by:
Increased tensile modulus (E) (33% up to 62%) and tensile strength (σ_{y}) (47% up to 83%) in relation to the polyolefin alone, i.e., these nanocomposites exhibit a greater/larger rigidity and high compatibilization among the nanoparticles and polyolefin phases, according to a greater tensile strength (σ_{y}).
The tensile modulus is greater for the nanocomposites prepared with hybrid nanoparticles NPSE or NPSL than the nanocomposites elaborated with nanoparticles non-hybrid NPS, i.e. the nanocomposites whose difference is being made with nanoparticles obtained by the sol-gel process that uses the aliphatic amine (NPSE or NPSL) or without the same (NPS). The increase is between 44%-62% for the nanoparticles prepared with nanoparticles as NPSE and NPSL compared to 33%-39% increase for the nanocomposites prepared with nanoparticles NPS (the values are % increase with respect to the polyolefin alone),
High elongation of break (ε) for the nanocomposites prepared with hybrid nanoparticles, in particular with the nanoparticles NPSE, i.e., “ε” values of about 50% for the polyolefin alone,
The rigidity of the nanocomposites is dependent on the melt flow index of the polyolefin, i.e., a higher melt flow index (3 up to 26) increases the rigidity, in particular for the nanocomposites prepared with hybrid nanoparticles NPSE or NPSL (45% up to 48% for nanocomposites with nanoparticles NPSE o from 47% up to 62% for nanocomposites with nanoparticles NPSL), and
The method for obtaining the Ziegler-Natta or metallocenic type of polyolefin, is an important factor in the increase of:
Stiffness in particular for nanocomposites elaborated with hybrid nanoparticles NPSL, i.e., to compare the values of stiffness (E) in the case of using polyolefin ZN340 or Met340 (increased from 47 to 53% compared with the polyolefin alone), and
Elastic limit (σ_{y}) especially for nanocomposites prepared with hybrid nanoparticles NPSL (increased from 67% to 73% compared with the polyolefin alone).

Furthermore nanocomposites based on polypropylene (PP), PP-g-AM as a compatibilizer and nanoparticles of aluminosilicate hybrid and laminar (NPSL) that have been obtained by a sol-gel process similar to obtaining hybrid and spherical silica nanoparticles having high dispersion (NPSE) of this invention (Example 1) presented mechanical properties (Table 5) is characterized by:
Greater rigidity (E) (4% up to 20%) and elastic limit (σ_{y}) (16% up to 33%) than nanocomposites that are based on the same PP and Mo nanoparticles of clay, or Hn or Hs,
Greater compatibility between the polymer matrix and nanoparticles of hybrid aluminosilicate (NPSL) than the polymer matrix and nanoparticles of clay Mo, or Hn or Hs according to the higher elastic limit (σ_{y}) of nanocomposites using nanoparticles NPSL than nanocomposites using clay (Mo, or Hn or Hs),
Greater increase in stiffness (E) by increase of the melt flow index of the PP in nanocomposites with NPSL nanoparticles than the nanocomposites with nanoparticles of clay Mo, or Hn or Hs, and
Higher stiffness (E) and elastic limit for nanocomposites based on metallocenic PP than in basis of Ziegler-Natta PP, both of similar melt flow index (ZN340 and Met 340) and with silica nanoparticles (NPSL) compared with the same nanocomposites but with clay nanoparticles Mo or Hn or Hs.

TABLE 4
Mechanical properties of the nanocomposites obtained with 1 wt. % of nanoparticles
obtained by modified Sol-Gel method of this invention (NPSE, NPSL or NPS),
3 wt. % of PP-g-AM and polypropylene Ziegler-Natta (ZN340 and ZN150)
and Metallocene (Met 340) of different melt flow index.

| | NPS | | | NPSE | | | NPSL | | |
|---|---|---|---|---|---|---|---|---|---|
| | E (MPa) ± | σ_{y} | ε | E (MPa) ± | σ_{y} | ε | E (MPa) ± | σ_{y} | ε |
| PP | 22 | (MPa) ± 2 | (%) | 31 | (MPa) ±± 2 | (%) | 28 | (MPa) ± 2 | (%) |
| ZN 340 | 1520 | 46 | 8 | 1590 | 55 | 160 | 1607 | 50 | 42 |
| ZN 150 | 1523 | 47 | 9 | 1620 | 52 | 90 | 1770 | 57 | 10 |
| Met 340 | 1480 | 47 | 9 | 1610 | 54 | 130 | 1711 | 52 | 50 |

E = Tensile Modulus;
σy = Tensile strength;
ε = Deformation at break

TABLE 5
Comparative mechanical properties of nanocomposites obtained with 1 wt. % of NPSL
or Mo, Hn and/or Hs clays and different melt flow index polypropylenes

| | NPSL | | Mo | | Hn | | Hs | |
|---|---|---|---|---|---|---|---|---|
| | E | | E | | E | | E | |
| | (MPa) ± | σy | (MPa) ± | σy | (MPa) ± | σy | (MPa) ± | σy |
| PP | 28 | (MPa) ± 2 | 37 | (MPa) ± 2 | 34 | (MPa) ± 1 | 39 | (MPa) ± 2 |
| ZN 340 | 1607 | 50 | 1310 | 34 | 1550 | 42 | 1410 | 39 |
| ZN150 | 1770 | 57 | 1415 | 38 | 1607 | 43 | 1405 | 41 |
| MET 340 | 1711 | 52 | 1452 | 43 | 1550 | 53 | 1380 | 40 |

E = Tensile Modulus;
σ_{y} = Tensile Strength

### Example 7

### Methodology for Obtaining Nanocomposites Based on Polyolefins, Polypropylene Grafted With Itaconic Acid (Pp-g-AI) and Nanoparticles NPSE or NPS

The polyolefin nanocomposite and nanoparticles of this invention described as follows, comprises the following raw materials i) polyolefin; ii) nanoparticles NPSE or NPS, iii) compatibilizers as polypropylene grafted with itaconic acid (PP-g-AI); and iv) antioxidant.

In this case the polyolefin compounds, nanoparticles NPSE or NPS, and antioxidant correspond to the same described in Example 4, and only changes the compatibilizer used. The compatibilizers used are: polypropylene grafted with itaconic acid where the grafted percentage of itaconic acid (AI) to the propylene changes from 0.7 to 1.3% by weight.

Additionally, this example describes the preparation of nanocomposites for previously obtaining the “masterbatch”, i.e., a mixture of nanoparticles and a compatibilizer with a particular composition which in this example belongs to a variable ratio of 1/1 to 1/5 by weight of nanoparticles/compatibilizer.

This example describes the stages for obtaining a propylene (PP ZN340) nanocomposite containing 1.0% by weight of NPSE nanoparticles by using a nanoparticles and compatibilizer masterbatch (PP-g-AI) with 0.7% of grafted AI in PP and a mass ratio of nanoparticles/compatibilizer equivalent to 1/5, as well as BTH as antioxidant and for a total mass of 35 grams, equivalent to the capacity of the Brabender non continuous mixer used, which comprises:
a) Obtaining nanoparticles NPSE by the methodology described in Example 1
b) Preparing the masterbatch comprising: mixing 29.1 grams of the compatibilizer PP-g-AI (0.7% AI grafted in PP), 0.03 grams of the antioxidant BHT in the Brabender non continuous mixer at 180-185° C. and 100-110 rpm. Additionally, adding dropwise, 28.2 ml of the suspension of nanoparticles NPSE (Example 1). After completing the addition of this suspension, the mixing is maintained during 10 minutes in a stream of inert gas, e.g., nitrogen, at 180-185° C. and 100-110 rpm. The masterbatch obtained has a ratio of nanoparticles NPSE/compatibilizer equal to 1/5.
c) Obtaining nanocomposite that comprising a mixture of: i) 2.10 grams of masterbatch ii) 32.90 g of commercial polypropylene ZN340, iii) 0.02 g of BHT as an antioxidant. This mixture is carried out in Brabender non continuous mixer at 190-195° C. and 100-110 rpm for 10 minutes under a stream of inert gas such as nitrogen, whose function is to move the oxidizing environment of air into the chamber and prevent the degradation of the polypropylene. The nanocomposite prepared in this manner contains 1.0% by weight of nanoparticles NPSE in the polymeric matrix.

The aforementioned procedure is valid for the nanocomposites with the nanoparticles NPS prepared according to Example 2, instead of nanoparticles NPSE.

Mechanical and Permeability Properties of the Nanocomposites Prepared in Example 7.

The tests carried out to verify the mechanical, and permeability properties of the nanocomposites prepared according to Example 7 were as follows:

1. The tensile mechanical tests according to ASTM D 638, to determine the tensile modulus (E) in (MPa), tensile strength (σy) in (MPa) and % (ε) of deformation at break. The results of the tests are presented in Table 6.

2. The permeability test determined by testing properties of transport was made in equipment showed in FIG. 7 and the results summarized in Table 7.

The permeability tests were made according to the following procedure: i) membrane preparation and ii) the subsequent determination of permeability.

### Preparation of Membranes

The dense membranes were prepared by pressing the polymer in a hydraulic press. The polymer was placed between two metal plates at 190° C.

At the time that the polymer is softened, the press is gradually closed until reaching a pressure of 50 bars, leaving the pressure during several minutes. Finally, the polymer is cooled by circulation of cold water between the plates. The thickness of the membranes obtained ranged from 0.10 to 0.05 millimeters.

Determination of Permeability

The permeability measured for pure N2 gas and O2 gas was determined by the “time-lag” method at 30° C. in the specified equipment of FIG. 7. The feeding pressure was kept at about 1.0 and 0.5 bar by the studied gases. The permeability cell was properly evacuated (close to 10⁻⁴ millibar). The measurement is controlled by a computer which automatically reports the permeability values.

TABLE 6
The mechanical properties of the nanocomposites based on PP,
NPS nanoparticles, and PP-g-AI with
different percentage of grafted AI.

| PP | AI grafted in PP (%) | E (MPa) | σ_{y} (MPa) | ε (%) |
|---|---|---|---|---|
| ZN 340 | 0.9 | 1228 ± 20 | 32 ± 1 | 201 |
| | 0.7 | 1214 ± 20 | 32 ± 1 | 25 |
| ZN 150 | 0.9 | 1348 ± 38 | 35 ± 1 | 5 |
| | 0.7 | 1547 ± 30 | 28 ± 1 | 3 |

E = Tensile Modulus (MPa),
σ_{y} = Elastic Limit (MPa),
ε = Deformation at break (%)

TABLE 7
Permeability (barrier) of the nanocomposites based on a PP (ZN26),
nanoparticles NPS and PP-g-AI with different percentages of grafted AI.

| | AI grafted | inPressure | N2 Permeability | O2 Permeability | | |
|---|---|---|---|---|---|---|
| Simple | PP (%) | (bar) | (barrier) | (barrier) | N2/O2 | O2/N2 |
| ZN 150 | — | P = 1 | 1.553 | 2.284 | 0.680 | 1.471 |
| ZN 150 | 0.9 | P = 0.5 | 1.522 | 4.74 | 0.321 | 3.114 |
| ZN 150 | 0.7 | P = 0.5 | 2.007 | 3.431 | 0.585 | 1.710 |

1 barrier = (1 * 10⁻¹⁰ cm³ (STP) cm)/(cm² * cmHg)

According to the results of the mechanical and permeability test of the nanocomposites obtained according to the methodology of Example 7, the following may be established:
Increased tensile modulus (E) (11% up to 42%) in relation to the polyolefin alone, i.e. these nanocomposites exhibit a larger stiffness and high compatibilization among the phases of nanoparticles and polyolefin,
The values of increase of the obtained tensile modulus using the PP-g-AI compatibilizer are similar to the rises obtained when the el PP-g-AM was used,
The membranes obtained comprise a greater selectivity of oxygen in comparison to the polypropylene alone,
The permeability and the ratio 02/N2 for the pure propylene and for the nanocomposite based on PP, PP-g-AI as compatibilizer with a grafted AI of 0.7%, are similar,
Increase in selectivity to 02 is presented when the PP-g-AI with a grafted AI of 0.9% as compatibilizer was used. This is because the permeability and the ratio 02/N2 for the pure polypropylene and for the material obtained showed a decrease in permeability to N2 and increased permeability to 02, becoming twice as compared to pure polymer.

We claim:

1. Hybrid silica nanoparticles with controlled morphology having uniform size, shape or both, comprising:
a) an aliphatic amine of 2-20 carbon atom, or
b) an alkoxide compound selected from the group consisting of siliceous alkoxide (R′_{(X)}—Si—(OR″)_{(4-X)}) and/or titanium alkoxide (R′_{(X)}—Ti—(OR″)_{(4-X)}) and/or zirconium alkoxide (R′_{(X)}—Zr—(OR″)_{(4-X)}), wherein R′ group can be equal or different that R″, and the R group in the chemical structure are between 1 to 18 carbon atoms, and mixtures thereof, having from one to four alkoxy groups; or
c) a combination of said aliphatic amine and said alkoxide compound.

2. The hybrid silica nanoparticles according to claim 1, wherein the aliphatic amine is 0.018 to 0.030 Molar, and wherein the nanoparticles are spherical and highly dispersed, have a high degree of purity, and are free of compounds that are toxic to human health, including cadmium and chromium.

3. A hybrid silica nanoparticles according to claim 1, wherein the concentration of the organosilane is 0.018 to 0.50 Molar, and wherein the nanoparticles are spherical and highly dispersed, have a high degree of purity, and are free of compounds that are toxic to human health, including cadmium and chromium.

4. A hybrid silica nanoparticles according to claim 1, wherein the aliphatic amine in a concentration range of the order of 1.8 to 3.0 Molar, and wherein the nanoparticles further comprises an aluminum salt, and are lamellar aluminosilicate nanoparticles that are highly dispersed and have a high degree of purity.

5. A hybrid nanoparticles according to claim 1, wherein the concentration of the organocompound is 0.5 to 5.0 Molar, and wherein the nanoparticles are lamellar silica nanoparticles that are highly dispersed, have a high degree of purity, and are free of compounds that are toxic to human health, including cadmium and chromium.

6. Use of the hybrid nanoparticles according to claim 1 to obtain nanocomposites using an extrusion process, with or without a compatibilizer agent.
